(19) United States
(12) Patent Application Publication
(10) Pub. No.: US 2015/0009843 A1
(43) Pub. Date: Jan. 8, 2015

(54) BASE STATION DEVICE, METHOD FOR DETERMINING ALLOWABLE OVERLAP NUMBER, ALLOWABLE OVERLAP NUMBER DETERMINATION PROGRAM, MOBILE STATION DEVICE, METHOD FOR TRANSMITTING ALLOWABLE OVERLAP NUMBER, AND ALLOWABLE OVERLAP NUMBER TRANSMISSION PROGRAM

(71) Applicant: Sharp Kabushiki Kaisha, Osaka-shi, Osaka (JP)

(72) Inventors: Hiroki Takahashi, Osaka-shi (JP); Jungo Goto, Osaka-shi (JP); Osamu Nakamura, Osaka-shi (JP); Kazunari Yokomakura, Osaka-shi (JP); Yasuhiro Hamaguchi, Osaka-shi (JP)

(73) Assignee: Sharp Kabushiki Kaisha, Osaka-shi, Osaka (JP)

(21) Appl. No.: 14/368,356

(22) PCT Filed: Dec. 20, 2012
(86) PCT No.: PCT/JP2012/083013

§ 371 Date: Jun. 24, 2014

(30) Foreign Application Priority Data
Dec. 26, 2011 (JP) 2011-284318

(51) Int. Cl. H04W 24/08; H04W 52/24

(52) U.S. Cl. CPC H04W 24/08; H04W 52/242; H04W 52/243
USPC 370/252

(57) ABSTRACT

An interference amount index obtaining unit 207 configured to obtain an index of an amount of interference of each mobile station device with another cell to which each mobile station device does not belong and allowable overlap number determination units 208-1 to 208-U configured to set, for the mobile station devices, allowable overlap numbers, each of which indicates the number of mobile station devices allowed to use the same frequency in an overlapped manner, in accordance with the indices of the amount of interference obtained by the interference amount index obtaining unit 207 are included.

### TECHNICAL FIELD

The present invention relates to a base station device, a method for determining an allowable overlap number, an allowable overlap number determination program, a mobile station device, a method for generating path loss information, and a path loss information generation program.

### BACKGROUND ART

Since a mobile station device is generally a transmission station in an uplink (communication from the mobile station device to a base station device) of a mobile communication system, the power efficiency of an amplifier can be kept high with limited transmission power, and therefore a single-carrier scheme in which peak power is low (for example, an SC-FDMA (single-carrier frequency-division multiple access) scheme is adopted in LTE (long term evolution), which is a 3.9 generation radio communication system for mobile phones) is considered effective.

It is to be noted that SC-FDMA is also referred to as DFT-S-OFDM (discrete Fourier transform spread orthogonal frequency-division multiplexing), DFT-precoded OFDM, or the like.

In LTE-A, in order to improve spectral efficiency, it has been decided to newly support an access scheme called clustered DFT-S-OFDM (also referred to as dynamic spectrum control (DSC), SC-ASA (single-carrier adaptive spectrum allocation), or the like), in which an SC-FDMA spectrum of a mobile station device having ample transmission power is divided into clusters, each of which is configured by a plurality of subcarriers.

In addition, in order to further improve the spectral efficiency, a scheme in which a plurality of mobile station devices are assigned (overlapped) to the same frequency is being examined. In an uplink MU-MIMO (multi-user multiple-input multiple-output) scheme, a base station device can receive spatially multiplexed transmission signals from mobile station devices that are fewer than or equal to the number of reception antennas thereof on a condition that the base station device includes a plurality of reception antennas.

Furthermore, as a scheme in which “signals more than the number of antennas of a base station device are overlapped (overloaded) at the same frequency”, an access scheme based on spectrum-overlapped resource management (SORM) has been proposed (for example, refer to PTL 1). In the SORM, a base station device allows the spectra of a plurality of mobile station devices to be overloaded at the same frequency on a condition that turbo equalization is used in a reception process. By canceling overlapped signals over and over using results (soft estimates) of detection of all connected mobile station devices in the turbo equalization process, the base station device gradually detects transmission data from each mobile station device. In the SORM, the base station device can obtain high scheduling gain because not frequency-division multiplexing but obtaining of higher channel gain takes priority in assignment of the spectrum of each mobile station device.

On the other hand, in uplink communication, transmission power control (TPC), in which transmission power necessary for the base station to receive data with a certain reception quality is controlled, is applied when each mobile station device transmits data. When the TPC has been applied, target reception power can be achieved with minimum necessary transmission power by compensating distance attenuation based on a distance from a connected base station and a path loss caused by shadowing. In addition, since each mobile station device transmits data with minimum necessary transmission power, interference with another cell can be suppressed to the minimum.

Furthermore, since a mobile station device with which the path loss is large transmits data with high transmission power because of the TPC, an effect of the mobile station device upon another cell is considered large, and therefore fractional TPC, which reduces a target reception level of the mobile station device with which the path loss is large, and the like have been examined and the fractional TPC is known as a technique for increasing the throughput of the entirety of a cell. This technique stably works in an existing cellular system in which radio resources are assigned to mobile station devices such that orthogonality is secured within the range of the radio resources included in the system, such as time-division multiple access (TDMA) or frequency-division multiple access (FDMA).

### CITATION LIST

### Patent Literature

PTL 1: International Publication No. 2009/022709

### SUMMARY OF INVENTION

### Technical Problem

When a scheme in which a plurality of mobile station devices use the same frequency for transmission at the same time, such as an access scheme based on the MU-MIMO or the SORM, is applied to a cellular system, a plurality of signals are multiplexed at a particular frequency because of the use (overlap) of the same frequency, and accordingly interference power at the frequency increases compared to when a scheme in which overlap is not performed is applied. In particular, if mobile station devices with which path losses are large and whose transmission power is high are allowed to overlap with each other, a problem arises in that interference power applied to another cell significantly increases at the frequency.

Therefore, the present invention has been established in view of the above problem, and aims to provide a technique for enabling a plurality of mobile station devices to use the same frequency for transmission at the same time while suppressing interference power applied to another cell.

### Solution to Problem

(1) The present invention has been established in view of the above circumstances, and an aspect of the present invention is a base station device including an interference amount index obtaining unit that obtains an index of an amount of interference of a mobile station device with another cell to which the mobile station device does not belong, and an allowable overlap number determination unit that sets, for the mobile station device, an allowable overlap number, which indicates the number of mobile station devices that are allowed to use the same frequency in an overlapped manner, in accordance with the index of the amount of interference obtained by the interference amount index obtaining unit.

(2) In an aspect of the present invention in the above-described base station device, the allowable overlap number determination unit decreases a value of the allowable overlap number as the amount of interference indicated by the index of the amount of interference becomes larger.

(3) In an aspect of the present invention in the above-described base station device, the allowable overlap number determination unit sets, on the basis of the index of the amount of interference, the mobile station device as either a mobile station device that allows another mobile station device to use a frequency band used by the mobile station device in an overlapped manner or a mobile station device that does not allow another mobile station device to use the frequency band in an overlapped manner.

(4) In an aspect of the present invention in the above-described base station device, the allowable overlap number determination unit sets, on the basis of the index of the amount of interference, the mobile station device as either a mobile station device whose allowable overlap number is smaller than the number of antennas of the base station device used for reception or a mobile station device whose allowable overlap number is equal to or larger than the number of antennas of the base station device used for reception.

(5) In an aspect of the present invention in the above-described base station device, the index of the amount of interference is information regarding a path loss between the base station device and the mobile station device.

(6) An aspect of the present invention in the above-described base station device further includes a reception unit that receives a path loss measurement signal that is transmitted from the mobile station device and whose transmission power level is known to the base station device. The interference amount index obtaining unit includes an uplink path loss measurement section that calculates, on the basis of the path loss measurement signal, an uplink path loss in transmission from the mobile station device to the base station device as the information regarding a path loss.

(7) In an aspect of the present invention in the above-described base station device, the allowable overlap number determination unit sets the allowable overlap number for the mobile station device with which the uplink path loss calculated by the uplink path loss measurement section is equal to or larger than a threshold to zero.

(8) An aspect of the present invention in the above-described base station device further includes a reception unit that receives the information regarding a path loss from the mobile station device. The allowable overlap number determination unit sets the allowable overlap number for the mobile station device in accordance with the information regarding a path loss received by the reception unit.

(9) In an aspect of the present invention in the above-described base station device, the information regarding a path loss is a value of a downlink path loss in transmission from the base station device to the mobile station device.

(10) In an aspect of the present invention in the above-described base station device, the information regarding a path loss is the allowable overlap number for the mobile station device.

(11) In an aspect of the present invention in the above-described base station device, the information regarding a path loss is a transmission power level of the mobile station device used for transmission.

(12) In an aspect of the present invention in the above-described base station device, the information regarding a path loss is information indicating a difference between available maximum transmission power of the mobile station device and transmission power necessary to achieve a certain reception signal level.

(13) In an aspect of the present invention in the above-described base station device, the allowable overlap number determination unit sets the allowable overlap number on the basis of a bandwidth of the mobile station device used for transmission.

(14) In an aspect of the present invention in the above-described base station device, the allowable overlap number determination unit sets, in accordance with the index of the amount of interference of the mobile station device with another cell, a ratio of a band in which the mobile station device is allowed to overlap with another mobile station in the same cell to a band of the mobile station device used for transmission.

(15) An aspect of the present invention in the above-described base station device further includes a scheduling unit that determines, on the basis of the allowable overlap number set by the allowable overlap number determination unit, a frequency used by the mobile station device for transmission.

(16) An aspect of the present invention is a method for determining an allowable overlap number executed by a base station device. The method includes an interference amount index obtaining procedure for obtaining an index of an amount of interference of a mobile station device with another cell to which the mobile station device does not belong, and an allowable overlap number determination procedure for determining the allowable overlap number, which indicates the number of mobile station devices allowed to use the same frequency in an overlapped manner, in accordance with the index of the amount of interference obtained in the interference amount index obtaining procedure.

(17) An aspect of the present invention is an allowable overlap number determination program for causing a computer of a base station device to execute an interference amount index obtaining step of obtaining an index of an amount of interference of a mobile station device with another cell to which the mobile station device does not belong, and an allowable overlap number determination step of determining an allowable overlap number, which indicates the number of mobile station devices allowed to use the same frequency in an overlapped manner, in accordance with the index of the amount of interference obtained in the interference amount index obtaining step.

(18) An aspect of the present invention is a mobile station device including a downlink path loss measurement unit that measures a downlink path loss using a signal received from a base station device, an allowable overlap number determination unit that sets an allowable overlap number, which indicates the number of other mobile station devices allowed to use the same frequency in the same cell in an overlapped manner, on the basis of the downlink path loss measured by the downlink path loss measurement unit, and a transmission unit that transmits the allowable overlap number set by the allowable overlap number determination unit to the base station device.

(19) An aspect of the present invention is a method for transmitting an allowable overlap number executed by a mobile station device. The method includes a downlink path loss measurement procedure for measuring a downlink path loss using a signal received from a base station device, an allowable overlap number determination procedure for determining the allowable overlap number, which indicates the number of other mobile station devices allowed to use the same frequency in the same cell in an overlapped manner, on the basis of the downlink path loss measured in the downlink path loss measurement procedure, and a transmission procedure for transmitting the allowable overlap number set in the allowable overlap number determination procedure to the base station device.

(20) An aspect of the present invention is an allowable overlap number transmission program that causes a computer of a mobile station device to execute a downlink path loss measurement step of measuring a downlink path loss using a signal received from a base station device, an allowable overlap number determination step of determining an allowable overlap number, which indicates the number of other mobile station devices allowed to use the same frequency in the same cell in an overlapped manner, on the basis of the downlink path loss measured in the downlink path loss measurement step, and a transmission step of transmitting the allowable overlap number set in the allowable overlap number determination step to the base station device.

### Advantageous Effects of Invention

According to the present invention, it is possible to enable a plurality of mobile station devices to use the same frequency for transmission at the same time while suppressing interference power applied to another cell.

### BRIEF DESCRIPTION OF DRAWINGS

FIG. 1 is a schematic diagram illustrating the concept of a radio communication system in the present invention.

FIG. 2 illustrates an example of power levels (average spectral densities) of signals transmitted from mobile station devices illustrated in FIG. 1.

FIG. 3 is a schematic block diagram illustrating a radio communication system according to a first embodiment.

FIG. 4 is a schematic block diagram illustrating a mobile station device according to the first embodiment.

FIG. 5 is a schematic block diagram illustrating a base station device according to the first embodiment.

FIG. 6 is a flowchart illustrating an example of a scheduling process performed by a scheduling unit according to the first embodiment.

FIG. 7 is a flowchart illustrating an example of a scheduling process performed by a scheduling unit according to a modification of the first embodiment.

FIG. 8 is a schematic block diagram illustrating a radio communication system according to a second embodiment.

FIG. 9 is a schematic block diagram illustrating a mobile station device according to the second embodiment.

FIG. 10 is a schematic block diagram illustrating a base station device according to the second embodiment.

FIG. 11 is a diagram illustrating an example of schematic blocks of a mobile station device according to a modification of the second embodiment.

FIG. 12 is an example of a schematic block diagram illustrating a base station device according to the modification of the second embodiment.

FIG. 13 is a diagram illustrating an example of spectral assignment in spectrum-overlapped resource management (SORM).

### DESCRIPTION OF EMBODIMENTS

Embodiments of the present invention will be described in detail hereinafter with reference to the drawings.

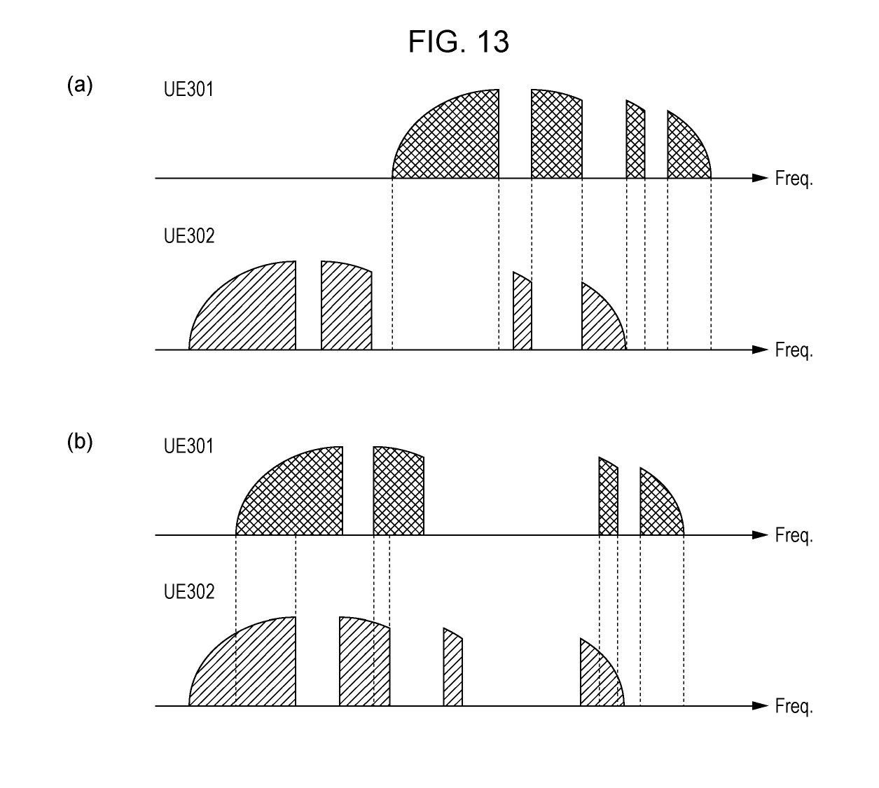

FIG. 13 is a diagram illustrating an example of spectral assignment in spectrum-overlapped resource management (SORM). In FIG. 13(a), subcarriers are assigned to two mobile station devices UE301 and UE302 by frequency-division multiplexing (FDM) without using the SORM. In this case, a base station device can easily separate signals from the pieces of UE from each other by assigning different frequencies to the UE301 and the UE302 (this state is referred to as being orthogonal).

On the other hand, in FIG. 13(b), subcarriers are assigned to the two pieces of UE, namely the UE301 and the UE302, using the SORM. In the SORM, the same subcarriers may be assigned to different pieces of UE (this state is referred to as being overlapped). That is, since non-orthogonal assignment may be performed in the SORM, the number of subcarriers that can be used by each piece of UE can be essentially increased compared to when the SORM is not used, and accordingly high scheduling gain can be obtained. However, signals from a plurality of pieces of UE that use the same subcarriers act as each other's interference at the base station device. Therefore, when the base station device includes one reception antenna (the number of reception antennas is smaller than the number of signals overlapped), it is difficult to separate the signals from each other through a linear process, and accordingly error rate characteristics deteriorate. For this reason, in the SORM, transmission data from each mobile station device is decoded using nonlinear iterative equalization (for example, turbo equalization) in a reception process.

By canceling overlapped signals over and over using results (soft estimates) of detection of all connected mobile station devices in the turbo equalization process, the base station device can gradually detect transmission data from each mobile station device.

It is to be noted that although a case in which the SORM is performed is assumed in the following embodiments, the present invention can be applied insofar as a scheme is used in which communication is performed while overlapping signals at least part of frequencies at the same time, such as MU-MIMO.

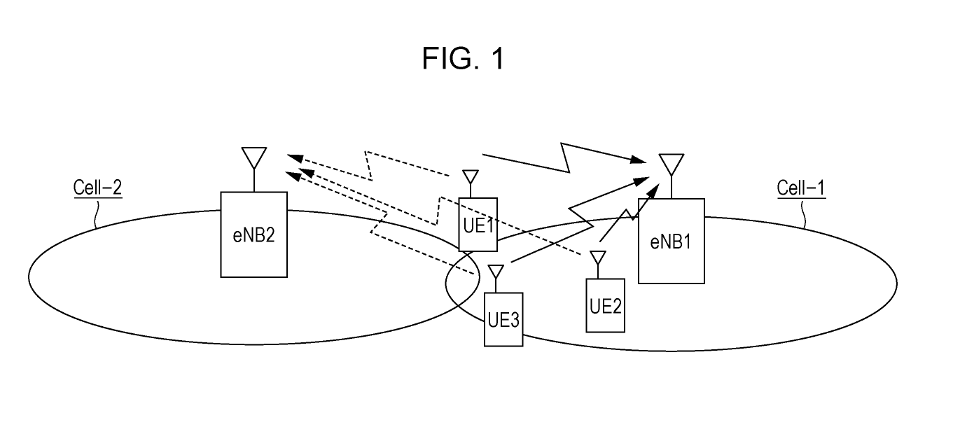

FIG. 1 is a schematic diagram illustrating the concept of a radio communication system in the present invention.

In FIG. 1, a cell Cell-1 covered by a first base station device eNB1 and a cell Cell-2 covered by a second base station device eNB2 are located adjacent to each other. In the following description, the first base station device eNB1 might be simply referred to as the eNB1 and the second base station device eNB2 might be simply referred to as the eNB2. In addition, FIG. 1 illustrates a state in which a first mobile station device UE1, a second mobile station device UE2, and a third mobile station device UE3 are transmitting their respective signals to the eNB1. In the following description, the mobile station device UE1 might be simply referred to as the UE1, the mobile station device UE2 might be simply referred to as the UE2, and the mobile station device UE3 might be simply referred to as the UE3. Here, the UE1 and the UE3 are located at a cell edge close to the eNB2, and the UE2 is located at the center of the cell close to the eNB1. Therefore, as indicated by broken lines, the eNB2 receives the signals of the UE1 and the UE3 as high level interference waves. That is, these interference waves interfere with a transmission signal transmitted to the eNB2 by a mobile station device (not illustrated) located in the cell Cell-2 covered by the base station device eNB2. On the other hand, the eNB2 receives the signal of the UE2 as a low level interference wave or does not receive the interference wave.

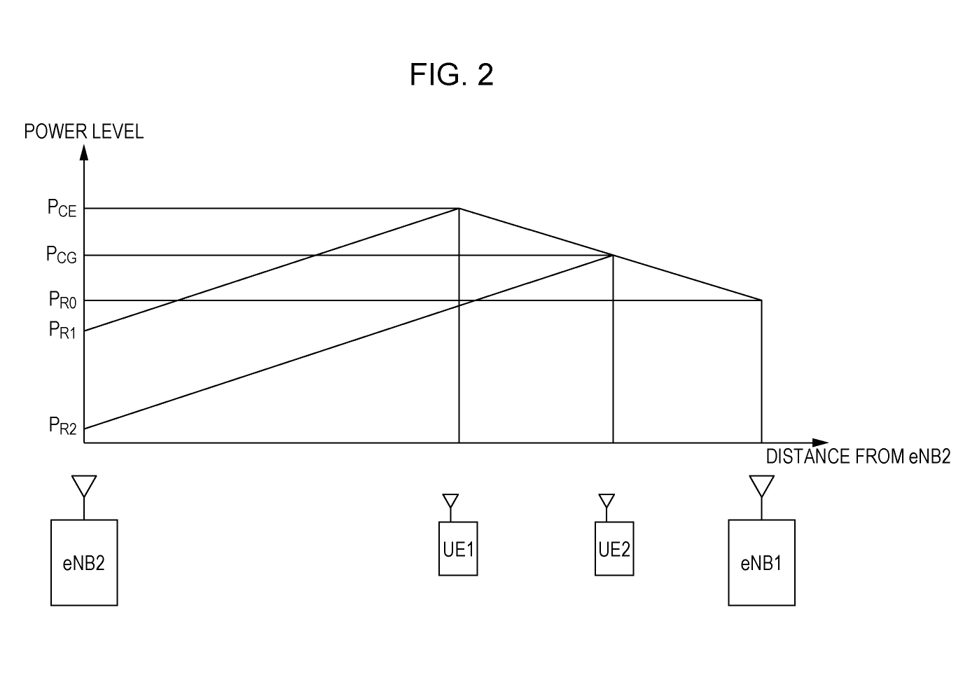

FIG. 2 illustrates an example of the power levels (average spectral densities) of the signals transmitted from the mobile station devices illustrated in FIG. 1. In the figure, a horizontal axis represents a distance from the eNB2, and it is assumed that the UE1 and the UE2 are located on a line between the eNB1 and the eNB2. In addition, in the figure, a vertical axis represents a power level at each frequency.

When the UE1 and the UE2 transmit signals to the eNB1, the transmission power level of the UE1, which is located at the cell edge, is, with a path loss considered, denoted by p_{CE} and the transmission power level of the UE2, which is located around the base station, is denoted by p_{CC} if a reception power level required to properly receive the signals at the eNB1 is denoted by pR0. Here, since p_{CE} is higher than p_{CC} and the UE1 is located closer to the eNB2 than the UE1, the reception power levels of the signals transmitted from the UE1 and the UE2 when the signals are received by the eNB2 as interference signals are p_{R1} and p_{R2}, respectively, and p_{R1} is considerably higher than p_{R2}. That is, the interference level of a signal transmitted from a mobile station device located at a cell edge can often be extremely higher in another cell than that of a signal transmitted from a mobile station device located around a base station.

Here, assume that the UE3, which is the other mobile station device, is located at the distance of the UE1 in FIG. 2, and the signal of the UE3 is overlapped with that of the UE1 or the UE2 at part of the frequencies using the SORM scheme and transmitted to the eNB1. Assume that the transmission power level of the UE3 is the same as that of the UE1, namely p_{CE}, and the reception signal power level of the signal of the UE3 received by the eNB2 is p_{R1}. In this case, at a frequency at which the signal of the UE1 and the signal of the UE3 overlap, the signals of the UE1 and the UE3 are added to each other, thereby increasing the reception power level of the interference waves to 2×p_{R1}, which means that the eNB2 receives the interference waves having a power level twice as high as that of interference waves at a time when the interference waves are not overlapped.

On the other hand, the power level of the interference waves when the signal of the UE2 and the signal of the UE3 are overlapped is p_{R1}+pR2. In this case, if p_{R2} is sufficiently small, the power level of the interference waves is approximately p_{R1}, which is substantially the same level as when the signals are not overlapped. Thus, when a scheme is used in which overlap is allowed between a plurality of mobile stations, there has been a problem in that interference with another cell undesirably increases compared to when the existing scheme is not used if even a mobile station device located at a cell edge is allowed to be overlapped.

### First Embodiment

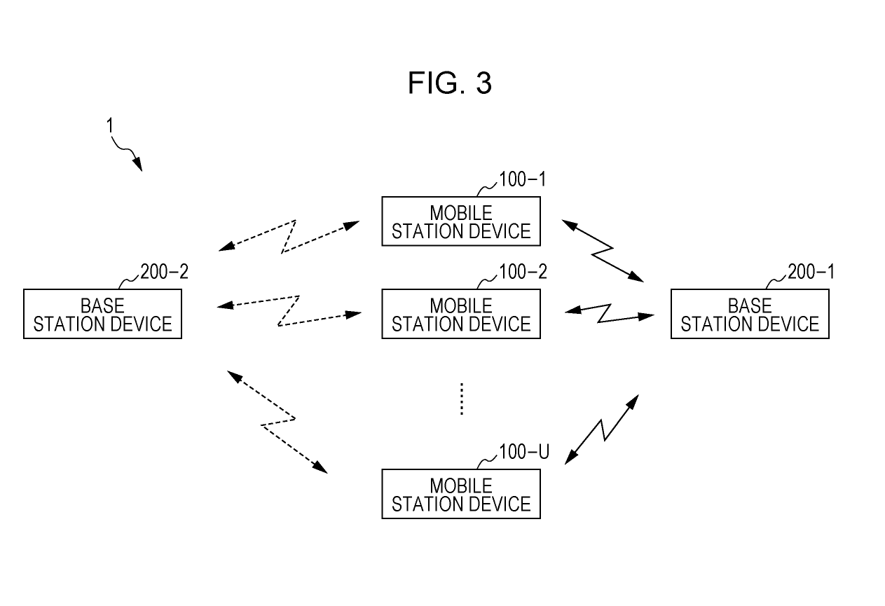

FIG. 3 is a schematic block diagram illustrating a radio communication system 1 according to a first embodiment. The radio communication system 1 includes base station devices 200-1 and 200-2 and mobile station devices 100-1, 100-2, . . . , and 100-U (U is a positive integer). Here, the base station device 200-1 or the base station device 200-2 will be generally referred to as a base station device 200. In addition, the mobile station device 100-1, 100-2, . . . , or 100-L will be generally referred to as a mobile station device 100. It is to be noted that although the number of base station devices is two as an example, the number of base station devices is not limited to this, and it is only required that two or more base station devices be used.

In order to recognize the amount of interference, with another cell, of a mobile station device 100 with which the base station device 200 communicates, the base station device 200 measures a path loss at a time when the base station device 200 has received a signal transmitted from the mobile station device 100 as an index of the amount of interference. When the path loss of a mobile station device 100 is large, the base station device 200 regards the mobile station device as located far therefrom. Here, in a cellular scheme in which transmission power control (TPC) is applied to an uplink, a mobile station device controls the transmission power thereof such that the level of a signal received by a base station device becomes a certain value or larger. In this type of control, the mobile station device does not notify the base station device of the determined transmission power, and therefore a transmission signal level is unknown to the base station device. In this case, the base station device cannot accurately measure the path loss, which is a difference between the transmission signal level and the reception signal level.

Therefore, in addition to a signal subjected to the TPC process in the uplink, the mobile station device 100 according to this embodiment transmits a path loss measurement signal with which the path loss can be measured by the base station 200. Here, the path loss measurement signal is an example of path loss information, which is information that can be used by a base station device for determining an allowable overlap number. The base station device 200 measures the path loss on the basis of the path loss measurement signal received from the mobile station device 100. The base station device 200 then sets, on the basis of the measured path loss, whether or not to allow the mobile station device 100 from which the path loss reference signal has been received to overlap frequencies used for communication with ones used by another mobile station device.

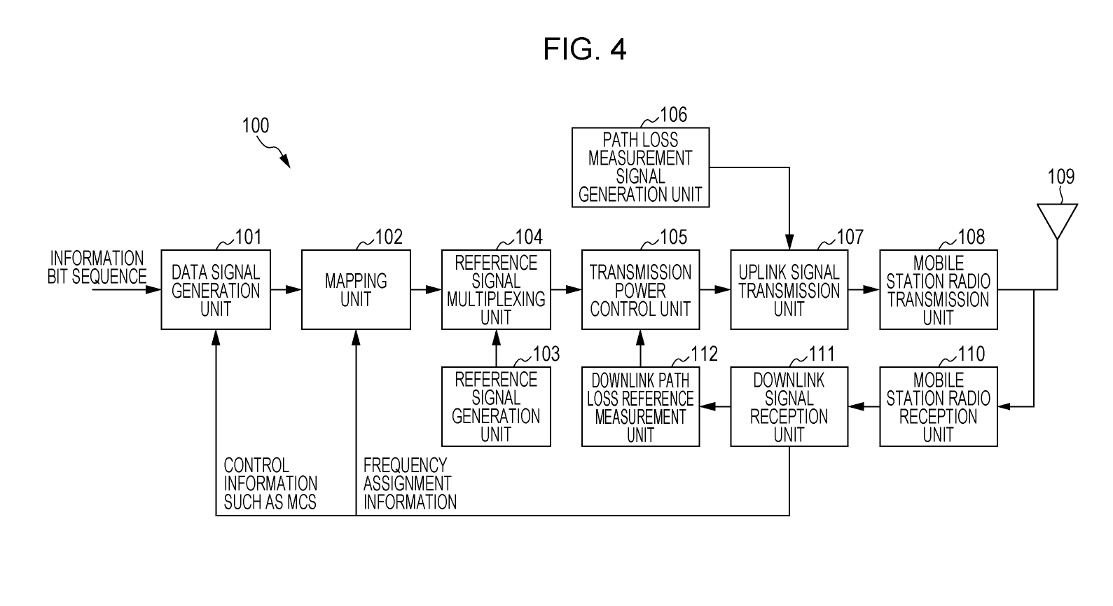

FIG. 4 is a schematic block diagram illustrating the mobile station device 100 according to the first embodiment. The mobile station device 100 includes a data signal generation unit 101, a mapping unit 102, a reference signal generation unit 103, a reference signal multiplexing unit 104, a transmission power control unit 105, a path loss measurement signal generation unit 106, an uplink signal transmission unit 107, a mobile station radio transmission unit 108, an antenna 109, a mobile station radio reception unit 110, a downlink signal reception unit 111, and a downlink path loss measurement unit 112. However, FIG. 4 is a block diagram illustrating minimum components necessary to describe the present invention, and illustration of other known components is omitted.

In addition, although the number of transmission and reception antennas of the mobile station device 100 is one in the figure, a plurality of antennas may be used for transmission and reception and a known technique such as transmission diversity transmission or MIMO transmission may be applied. Here, the number of antennas is not limited to the number of physical antennas, but the number of antenna ports may be used, instead. When a plurality of antennas can be regarded as physically identical, the number of antenna ports is one.

The mobile station radio reception unit 110 receives a downlink signal transmitted from the base station device 200 through the antenna 109. The mobile station radio reception unit 110 down-converts the downlink signal input from the antenna 109 from a transmission frequency band, and then converts the signal into a digital signal through A/D conversion. Thereafter, the mobile station radio reception unit 110 outputs the digital signal after the conversion to the downlink signal reception unit 111.

The downlink signal reception unit 111 outputs the digital signal to another component in accordance with whether the digital signal input from the mobile station radio reception unit 110 is a data signal or a control signal. Here, components relating to an uplink signal will be described. If the input digital signal is a control signal, the downlink signal reception unit 111 outputs control information included in the digital signal, such as an error correction coding rate and MCSs (modulation and coding schemes) indicating a modulation scheme, to the data signal generation unit 101.

In addition, the downlink signal reception unit 111 outputs frequency assignment information included in the digital signal to the mapping unit 102. In addition, the downlink signal reception unit 111 outputs a downlink signal included in the digital signal to the downlink path loss measurement unit 112 as necessary in order to measure the path loss. The downlink signal used for measuring the path loss may be a reference signal for measuring reception power generated by the base station device, or a signal used for another process may be used for measuring the path loss.

The data signal generation unit 101 obtains an information bit sequence, and performs error correction coding on the obtained information bit sequence using the MCS information input from the downlink signal reception unit 111. The data signal generation unit 101 then performs modulation such as quaternary phase-shift keying modulation (QPSK) or 16-ary quadrature amplitude modulation (16-QAM) on the signal subjected to the error correction coding. Thereafter, the data signal generation unit 101 outputs a modulated signal obtained as a result of the modulation to the mapping unit 102.

The mapping unit 102 transforms the modulated signal input from the data signal generation unit 101 from a time-domain signal into a frequency-domain signal through a DFT (discrete Fourier transform). The mapping unit 102 then maps the frequency-domain signal after the transform at a frequency specified by the frequency assignment information input from the downlink signal reception unit 111.

Thereafter, the mapping unit 102 transforms a signal obtained as a result of the mapping into a time-domain signal through an IFFT (inverse fast Fourier transform). The mapping unit 102 then outputs the time-domain signal obtained as a result of the transform to the reference signal multiplexing unit 104. If a multicarrier scheme is adopted as a transmission scheme, however, the mapping unit 102 may directly map the input signal at a specified frequency as a frequency-domain signal.

The reference signal generation unit 103 generates a reference signal for measuring channel information necessary for the base station device 200 to perform scheduling, and outputs the reference signal to the reference signal multiplexing unit 104. The reference signal multiplexing unit 104 multiplexes the time-domain signal input from the mapping unit 102 and the reference signal input from the reference signal generation unit 103, and outputs a multiplexed signal obtained as a result of the multiplexing to the transmission power control unit 105.

The downlink path loss measurement unit 112 measures the reception power level of the downlink signal input from the downlink signal reception unit 111. As the downlink signal used for the measurement, for example, a reference signal (also referred to as a CRS) for measuring the reception power level transmitted from the base station device 200 may be used, but another signal may be used insofar as the measurement can be performed. The downlink path loss measurement unit 112 calculates a logarithm ratio of “reception power level/transmission power level” on the basis of the measured “reception power level of the reference signal” and a known “transmission power level of the reference signal” transmitted from the base station device 200 as the path loss. However, the transmission power level of a signal used for the measurement need not be transmitted from the base station device 200 but may be a fixed value insofar as the value is predetermined in the system. The downlink path loss measurement unit 112 outputs the calculated path loss to the transmission power control unit 105.

The transmission power control unit 105 sets a transmission power level for realizing a reception power level specified by the base station device 200 on the basis of the path loss input from the downlink path loss measurement unit 112. However, the transmission power control unit 105 may set the transmission power level on the basis of the MCS or a parameter specified by the base station device 200 such as a correction value instead of the path loss. More specifically, for example, the transmission power control unit 105 sets the transmission power in accordance with the following expression.

P_{T0}=min(P_{MAX},P_{NEED}) (1)

Here, min(a, b) denotes a function that uses a or b, whichever is smaller, and P_{MAX} denotes maximum transmission power that can be used by the mobile station device. P_{NEED} denotes transmission power necessary to realize a target reception level and is calculated by the following expression.

P_{NEED}=p_{R0}+α×PL+10 log₁₀(W)+F (2)

Here, p_{R0} denotes a nominal target reception power level at each frequency, and α denotes a cell-specific parameter set between and including 0 and 1. W denotes a bandwidth assigned to the mobile station device 100, and F denotes a value for correcting a transmission power level that does not depend on the bandwidth, such as the MCS.

Thereafter, the transmission power control unit 105 amplifies the multiplexed signal input from the reference signal multiplexing unit 104 using a PA (power amplifier). The transmission power control unit 105 then outputs the amplified signal to the uplink signal transmission unit 107. It is to be noted that the transmission power control unit 105 may receive another signal such as control information as necessary in addition to the data signal and the reference signal and perform the same process on the other signal such as control information that has been received.

The path loss measurement signal generation unit 106 generates a path loss measurement signal with which the base station device 200 can recognize the transmission power level in order for the base station device 200 to measure an uplink path loss. The path loss measurement signal generation unit 106 then outputs the generated path loss measurement signal to the uplink signal transmission unit 107. It is to be noted that the path loss measurement signal may be an arbitrary signal used for another use insofar as the signal is not subjected to transmission power control such as that performed by the transmission power control unit 105.

The uplink signal transmission unit 107 outputs the amplified signal input from the transmission power control unit 105 and the path loss measurement signal input from the path loss measurement signal generation unit 106 to the mobile station radio transmission unit 108 using a predetermined frame.

The mobile station radio transmission unit 108 performs D/A (digital-to-analog) conversion on the signal input from the uplink signal transmission unit 107 and up-converts the signal to the transmission frequency band. The mobile station radio transmission unit 108 then transmits a transmission signal obtained as a result of the up-conversion to the base station device 200 through the antenna.

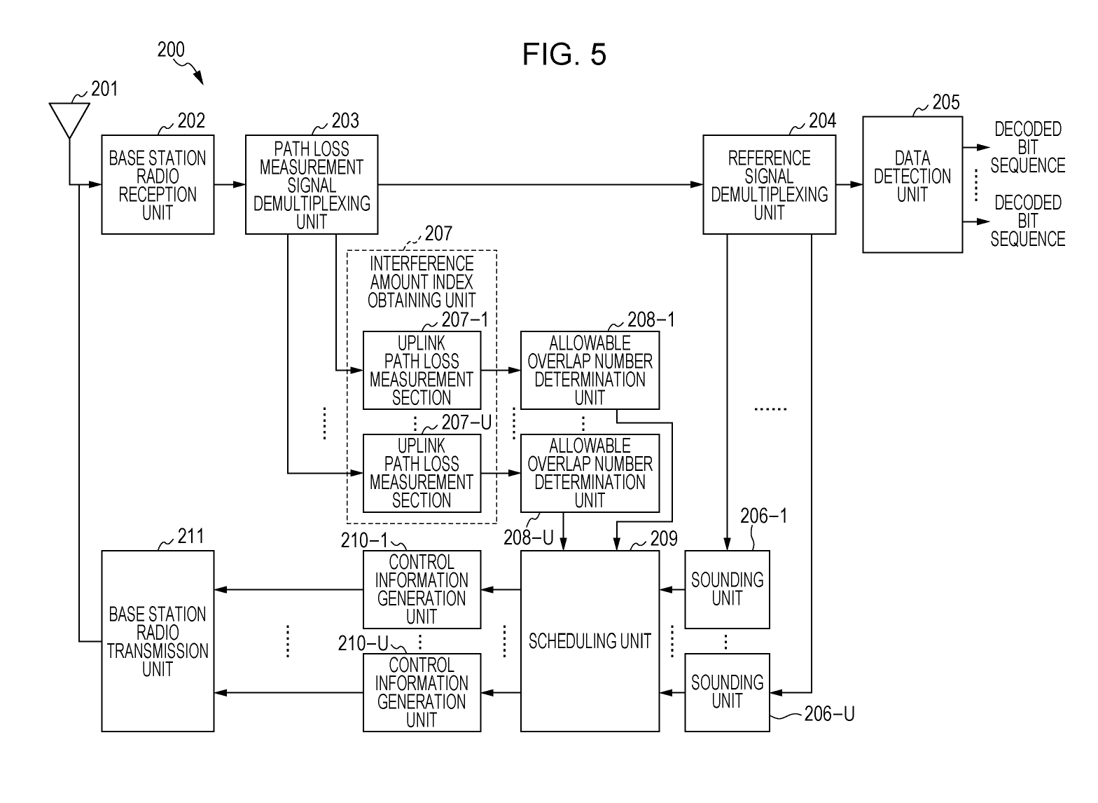

An example of the configuration of the base station device 200 according to this embodiment will be described with reference to FIG. 5. FIG. 5 is a schematic block diagram illustrating the base station device 200 according to the first embodiment. The base station device 200 includes an antenna 201, a base station radio reception unit (reception unit) 202, a path loss measurement signal demultiplexing unit 203, a reference signal demultiplexing unit 204, a data detection unit 205, sounding units 206-1, . . . , and 206-U, an interference amount index obtaining unit 207, allowable overlap number determination units 208-1, . . . , and 208-U, a scheduling unit 209, control information generation units 210-1, . . . , and 210-U, and a base station radio transmission unit 211. In addition, the interference amount index obtaining unit 207 includes uplink path loss measurement sections 207-1, . . . , and 207-U.

Here, assume that the configuration of the base station device 200 at a time when there are U mobile station devices 100 having the configuration illustrated in FIG. 4 and the base station device 200 simultaneously receives signals from the mobile station devices 100 is illustrated, and the base station device 200 can receive signals from an arbitrary number of mobile station devices. In addition, although the number of antennas in this embodiment is one, a plurality of antennas may be included.

The base station radio reception unit 202 receives transmission signals transmitted from the mobile station devices 100 through the antenna 201, and down-converts the received transmission signals from the transmission frequency band. The base station radio reception unit 202 then performs A/D conversion on the signals obtained as a result of the down-conversion to convert the signals into digital signals, and outputs the digital signals after the conversion to the path loss measurement signal demultiplexing unit 203.

If the digital signals input from the base station radio reception unit 201 are data signals or reference signals, the path loss measurement signal demultiplexing unit 203 outputs the digital signals to the reference signal demultiplexing unit 204. On the other hand, if the digital signals are path loss measurement signals, the path loss measurement signal demultiplexing unit 203 demultiplexes the digital signals for each mobile station device 100, which is a source, and outputs each signal after the demultiplexing to the corresponding uplink path loss measurement section 207-i (i is an integer from 1 to U). More specifically, for example, the path loss measurement signal demultiplexing unit 203 outputs the path loss signal transmitted from the mobile station device 100-i to the path loss measurement unit 207-i having the same index i.

The reference signal demultiplexing unit 204 demultiplexes reference signals transmitted from the mobile station devices 100 from the signals input from the path loss measurement signal demultiplexing unit 203, and outputs each reference signal obtained as a result of the demultiplexing to the corresponding sounding unit 206-i. More specifically, for example, the reference signal demultiplexing unit 204 outputs the reference signal transmitted from the mobile station device 100-i to the sounding unit 206-i having the same index i. In addition, the reference signal demultiplexing unit 204 outputs signals other than the reference signals among the input signals to the data detection unit 205.

The data detection unit 205 demaps signals at each frequency used by the mobile station devices 100 for the transmission from the data signals input from the reference signal demultiplexing unit 204. The data detection unit 205 then performs processes such as equalization and modulation, and decodes transmission bits to obtain decoded bit sequences of the mobile station devices 100.

It is to be noted that, in the equalization process, the data detection unit 205 may use a nonlinear iterative equalization technique such as turbo equalization. When the orthogonality of the signals can be spatially maintained between the mobile station devices 100 by the base station device 200 by using a plurality of antennas, such as in a MU-MIMO system, however, the data detection unit 205 need not use a nonlinear iterative equalization technique and may perform a linear equalization process.

The sounding unit 206-i calculates, on the basis of the reference signal input from the reference signal demultiplexing unit 204, a frequency response in a band in which assignment to the mobile station device 100 is possible, and outputs the calculated frequency response to the scheduling unit 209. The interference amount index obtaining unit 207 obtains, on the basis of each transmission signal received by the base station radio reception unit 202, an index of the amount of interference (for example, an uplink path loss in the transmission from each mobile station device 100 to the base station device 200) applied by each mobile station device to another cell to which each mobile station device does not belong.

The uplink path loss measurement section 207-i measures the reception power level of the path loss reference signal input from the path loss measurement signal demultiplexing unit 203. Here, as described with respect to the configuration of the mobile station device 100, the transmission power level of the path loss measurement signal is known to the base station device 200. Therefore, the uplink path loss measurement section 207-i calculates an uplink path loss by subtracting the measured reception power level from the transmission power level, and outputs the calculated uplink path loss to the allowable overlap number determination unit 208-i having the same index i. Here, the uplink path loss is an example of information regarding a path loss between the base station device 200 and each mobile station device 100.

The allowable overlap number determination unit 208-i sets an allowable overlap number for the mobile station device 100-i on the basis of the uplink path loss of the mobile station device 100-i input from the uplink path loss measurement section 207-i. Here, the allowable overlap number refers to the number of mobile station devices that can use the same frequency as the mobile station device 100-i for transmission. For example, when the mobile station device 100-1 is assigned to bands f1 and f2 and the allowable overlap number is two, a maximum of two mobile station devices can be assigned to each of the bands f1 and f2 in addition to the mobile station device 100-1. However, these other mobile station devices may be different between the band f1 and the band f2.

However, although the allowable overlap number determination units 208-i are independent blocks for the corresponding mobile station devices in FIG. 5, the allowable overlap numbers may be set by the same block. In addition, when the same block is used, the allowable overlap number for each mobile station device may be relatively set on the basis of uplink path losses corresponding to the plurality of mobile station devices.

It is assumed in this embodiment, however, that the mobile station devices 100 are used with which the transmission power used thereby for transmission is constant regardless of the number of transmission antennas used by each mobile station device 100. When the mobile station devices 100 whose transmission power at each frequency changes in accordance with the number of transmission antennas used are used, the allowable overlap number need not be the number of mobile station devices but may be the total number of transmission antennas of the mobile station devices that use the same bands, in view of an object of the present invention to control the amount of interference with another cell.

In this embodiment, a case in which the allowable overlap number determination unit 208-i sets whether or not to allow the mobile station device to overlap with another mobile station device will be described as an example of the base station device 200 including one reception antenna. That is, the allowable overlap number determination unit 208-i determines whether the uplink path loss input from the uplink path loss measurement section 207-i is equal to or larger than a predetermined threshold or smaller than the threshold. If the uplink path loss is equal to or larger than the threshold, the mobile station device is not allowed to overlap, that is, the allowable overlap number is set to zero. If the uplink path loss is smaller than the threshold, the mobile station device is allowed to overlap, that is, the allowable overlap number is unlimited.

However, the process for determining the allowable overlap number is not limited that according to this embodiment. For example, the allowable overlap number determination unit 208-i may prepare a plurality of thresholds and set the allowable overlap number in accordance with the value of the uplink path loss. More specifically, for example, the allowable overlap number determination unit 208-i may set a larger allowable overlap number as the value of the uplink path loss becomes smaller. In addition, for example, when the base station device includes a plurality of reception antennas, the allowable overlap number determination unit 208-i may classify the allowable overlap number into “the number of reception antennas—1” and “unlimited” in comparison with the threshold. The allowable overlap number determination unit 208-i transmits the set allowable overlap number to the scheduling unit 209.

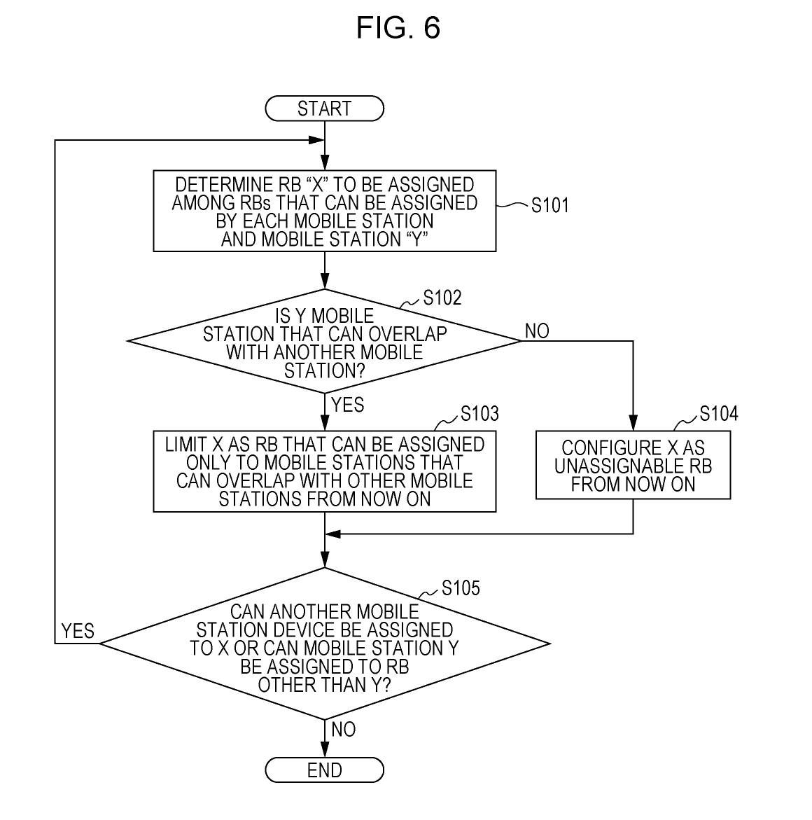

The scheduling unit 209 determines a frequency used by each mobile station device 100 for transmission on the basis of the allowable overlap number set by the allowable overlap number determination unit 208-i. The scheduling unit 209 determines a frequency band assigned to each mobile station device 100 on the basis of the frequency response for each mobile station device 100 input from the sounding unit 206-i and the allowable overlap number for each mobile station device 100 input from the allowable overlap number determination unit 208-i. An example of scheduling performed by the scheduling unit 209 according to the first embodiment will be described with reference to a flowchart of FIG. 6.

FIG. 6 is a flowchart illustrating an example of the scheduling process performed by the scheduling unit 209 according to the first embodiment. Here, a minimum unit of assignment will be referred to as a resource block (RB). First, the scheduling unit 209 determines an RB “X” to be assigned and a mobile station device “Y” to be assigned on the basis of all RBs that can be assigned by each mobile station device 100 (step S101). More specifically, for example, when there are RB1 to RB4, which are RBs that can be assigned, the RB “X” for obtaining highest gain is assigned to a mobile station device Y with which the highest gain can be obtained. Here, assignment is not performed for the other mobile station devices. It is to be noted that, in the determination process, the scheduling unit 209 uses an assignment method such as proportional fairness (PF), maximum carrier-to-interference ratio (Max CIR), or round robin (RR).

Next, the scheduling unit 209 determines whether or not the mobile station device Y is a mobile station device that can overlap with another mobile station device (whose allowable overlap number is unlimited) on the basis of the allowable overlap number input from the scheduling unit 209 (step S102). Next, if the mobile station device Y can overlap with another mobile station device (YES in step S102), the scheduling unit 209 limits the assigned RB “X” as an RB that can be assigned only to mobile station devices 100 that can overlap with other mobile station devices from now on (step S103). As a result, it becomes possible to prevent a mobile station device that cannot overlap with another mobile station device and the mobile station device Y, which has been assigned this time, from being assigned to the RB “X” in an overlapped manner.

If the mobile station device Y cannot overlap with another mobile station device (the allowable overlap number is zero) (NO in step S102), the RB “X” is configured as an unassignable RB, to which all the other mobile station devices cannot be assigned, since the mobile station device Y cannot be assigned to the same RB as the other mobile station devices. As a result, the scheduling unit 209 prevents the mobile station device Y and another mobile station device from being assigned to the RB “X” in an overlapped manner.

After step S103 or step S104, the scheduling unit 209 determines whether or not another mobile station device can be assigned to the RB “X” under conditions under which the RB “X” has been assigned to the mobile station device Y or whether or not there is an RB to which the mobile station device Y can be assigned in addition to the RB “X”. If another mobile station device can be assigned to the RB “X” or if there is an RB to which the mobile station device Y can be assigned in addition to the RB “X”, the scheduling unit 209 returns to step S101 to continue the scheduling.

If another mobile station device cannot be assigned to the RB “X” or if there is no RB to which the mobile station device Y can be assigned in addition to the RB “X”, the scheduling unit 209 ends the scheduling. Thus, the process illustrated in this flowchart ends. By performing such a process, the scheduling unit 209 can realize assignment of a frequency to which only mobile station devices 100 that can overlap with other mobile station devices are assigned.

After determining an RB to be assigned to each mobile station device 100-i, the scheduling unit 209 calculates interference noise power for each mobile station device 100-i. The scheduling unit 209 outputs determined frequency assignment information regarding each mobile station device 100-i, the frequency response of a frequency assigned to each mobile station device 100-i, and the interference noise power calculated for each mobile station device 100-i to the corresponding control information generation unit 210-i.

The control information generation unit 210-i determines an available MCS on the basis of the input frequency assignment information, frequency response, and interference noise power. The control information generation unit 210-i then outputs the frequency assignment information and the MCS to the base station radio transmission unit 211 as control information. However, the control information may include another piece of information necessary for the mobile station device 100 to perform uplink communication.

The base station radio transmission unit 211 performs D/A conversion on a control signal configured by the control information input from the control information generation unit 210-i. The base station radio transmission unit 211 then up-converts a signal after the D/A conversion into the transmission frequency band. Thereafter, the base station radio transmission unit 211 transmits a signal after the up-conversion to the mobile station device 100 through the antenna 201. In order for each mobile station device to measure a downlink path loss, however, the base station radio transmission unit 211 has a function of receiving a signal whose transmission power level is known to the mobile station device 100, such as a downlink data signal, and transmitting, in addition to the control signal, the received signal after performing the same process on the received signal.

Thus, in this embodiment, the base station device 200 performs the following process while taking into consideration that the uplink path loss of a signal from a mobile station device 100 located far from the base station device 200 and close to another cell is large at the base station device 200. The base station device 200 measures the reception signal level of a path loss measurement signal from the mobile station device 100, and calculates the uplink path loss from the measured reception signal level. The base station device 200 then sets the allowable overlap number for allowing the mobile station device 100 to share an RB on the basis of the calculated uplink path loss.

As a result, in particular, the base station device 200 can prevent a frequency band assigned to a mobile station device 100 located at a cell edge and a frequency band assigned to another mobile station device from overlapping, thereby suppressing the amount of interference with another cell.

<Modification>

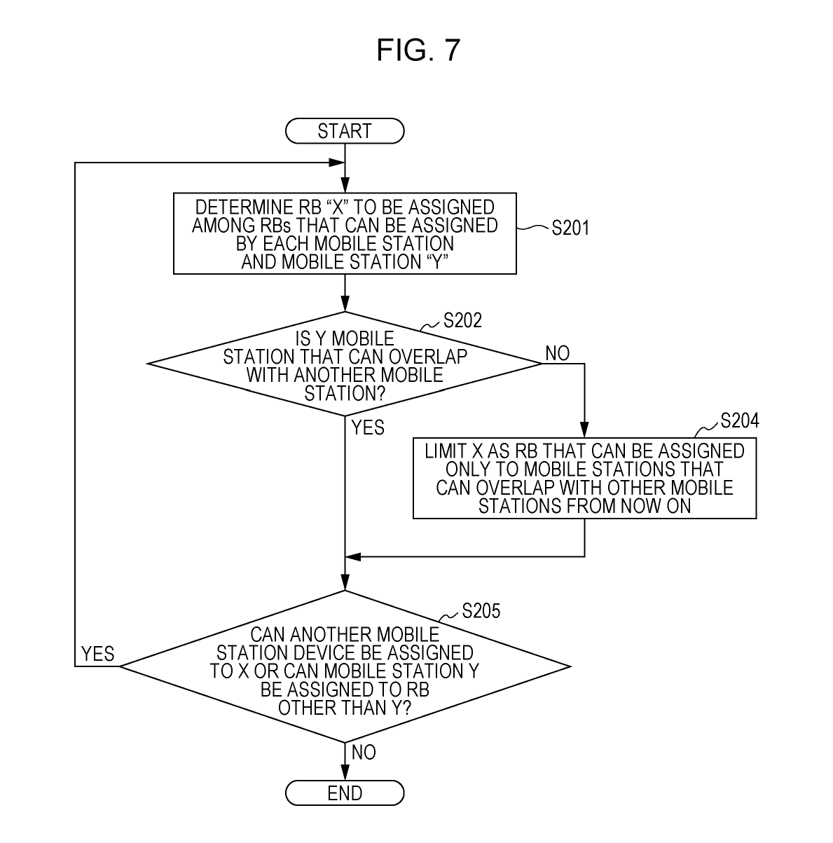

Although the scheduling is performed such that the frequency band of a mobile station device 100 that cannot overlap with another mobile station device, the frequency band being used for communication, does not overlap with the frequency band of another mobile station device in this embodiment, scheduling may be performed such that, as a modification, only the frequency bands of mobile station devices 100 that cannot overlap with other mobile station devices do not overlap with each other, instead. This is because, compared to when mobile station devices at a cell edge are overlapped with each other in a frequency band used for communication, the amount of interference with another cell does not significantly increase when a mobile station device at the cell edge and a mobile station device around a base station overlap with each other. Scheduling in this case will be described with reference to a flowchart of FIG. 7.

FIG. 7 is a flowchart illustrating an example of the scheduling performed by the scheduling unit 209 according to the modification of the first embodiment. It is to be noted that processing in step S201 and step S205 is the same as that in step S101 and step S105, respectively, illustrated in FIG. 6, and accordingly description thereof is omitted. Between the flowchart of FIG. 7 and the flowchart of FIG. 6, processing performed after the determination in step S202 is different.

In step S202, the scheduling unit 209 determines whether or not the mobile station device Y is a mobile station device that can overlap with another mobile station device (the allowable overlap number is unlimited) (step S202). If the mobile station device Y is a mobile station that can overlap with another mobile station device (the allowable overlap number is unlimited) (YES in step S202), the scheduling unit 209 does not change an assignable RB for another mobile station device and proceeds to step S205.

On the other hand, if the mobile station device Y is a mobile station device that cannot overlap with another mobile station device (the allowable overlap number is zero), the scheduling unit 209 proceeds to step S204. In step S204, the scheduling unit 209 determines the X, which is an RB assigned to the mobile station device Y, as an RB to which only mobile station devices that can overlap with other mobile station devices can be assigned (step S204), and proceeds to step S203. As a result, the scheduling unit 209 prevents the Y, which is a mobile station device that cannot overlap with another mobile station device, from overlapping only with other mobile station devices that cannot overlap with other mobile station devices. By performing such scheduling, the scheduling unit 209 can perform band assignment in such a way as to allow a mobile station that cannot overlap with another mobile station and a mobile station that can overlap with another mobile station to overlap with each other and prevent mobile station devices that cannot overlap with other mobile station devices from overlapping with each other.

In addition, although the allowable overlap number determination unit 208-i determines a mobile station device that is allowed to overlap with another mobile station device and a mobile station device that is not allowed to overlap with another mobile station device on the basis of uplink path losses in this embodiment, the way of the determination is not limited to this. The allowable overlap number determination unit 208-i may set the percentage of a bandwidth that can overlap for each mobile station device 100, instead. For example, the allowable overlap number determination unit 208-i defines, relative to a bandwidth assigned to the mobile station device 100, the percentage of a bandwidth that can overlap with another mobile station device as the percentage of overlap, and uniquely sets an allowable percentage of overlap in accordance with the value of an uplink path loss. Here, the allowable overlap number determination unit 208-i may calculate the allowable percentage of overlap on the basis of an expression, or may prepare a table illustrating correspondences between the uplink path loss and the allowable percentage of overlap and set the allowable percentage of overlap on the basis of the table.

By using such a configuration, the allowable overlap number determination unit 208-i can limit the size of an overlapping bandwidth stepwise as the transmission power level of a mobile station device becomes higher, thereby limiting the amount of interference with another cell caused by overlap.

### Second Embodiment

In the first embodiment, the base station device 200 measures the uplink path loss on the basis of the path loss measurement signal transmitted from the mobile station device 100, and sets the allowable overlap number for the mobile station device 100 in accordance with the value of the measured uplink path loss.

In a radio system adopting the TPC, however, a signal to which the TPC is not applied needs to be transmitted as the path loss measurement signal, which is burdensome in terms of the overhead of the signal and a circuitry configuration. In this embodiment, an embodiment will be described in which the mobile station device transmits a signal including information regarding a path loss measured in the downlink to the base station device.

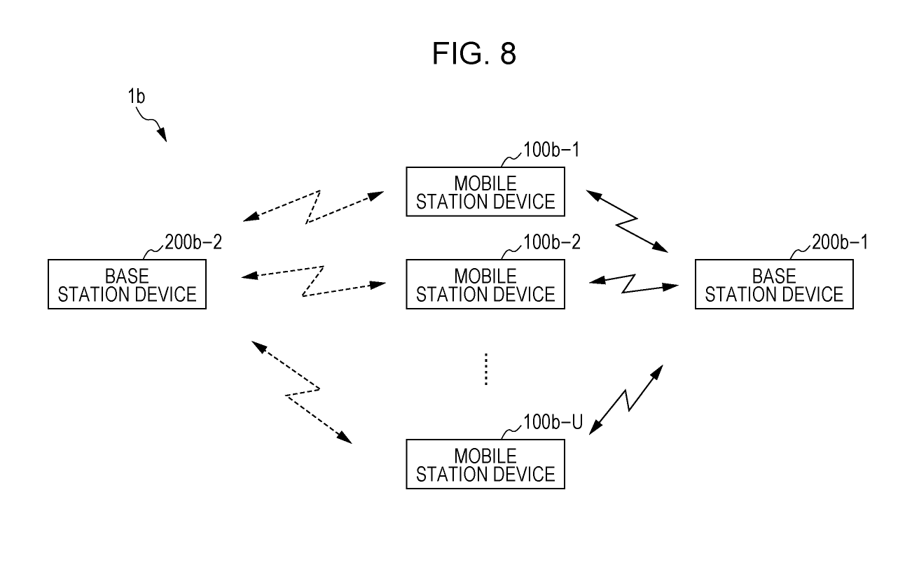

FIG. 8 is a schematic block diagram illustrating a radio communication system 1b according to the second embodiment. In the configuration of the radio communication system 1b according to the second embodiment illustrated in FIG. 8, the mobile station devices 100-i are changed to mobile station devices 100b-i and the base station devices 200-1 and 200-2 are changed to base station device 200b-1 and 200b-2, respectively, compared to the configuration of the radio communication system 1 according to the first embodiment illustrated in FIG. 3.

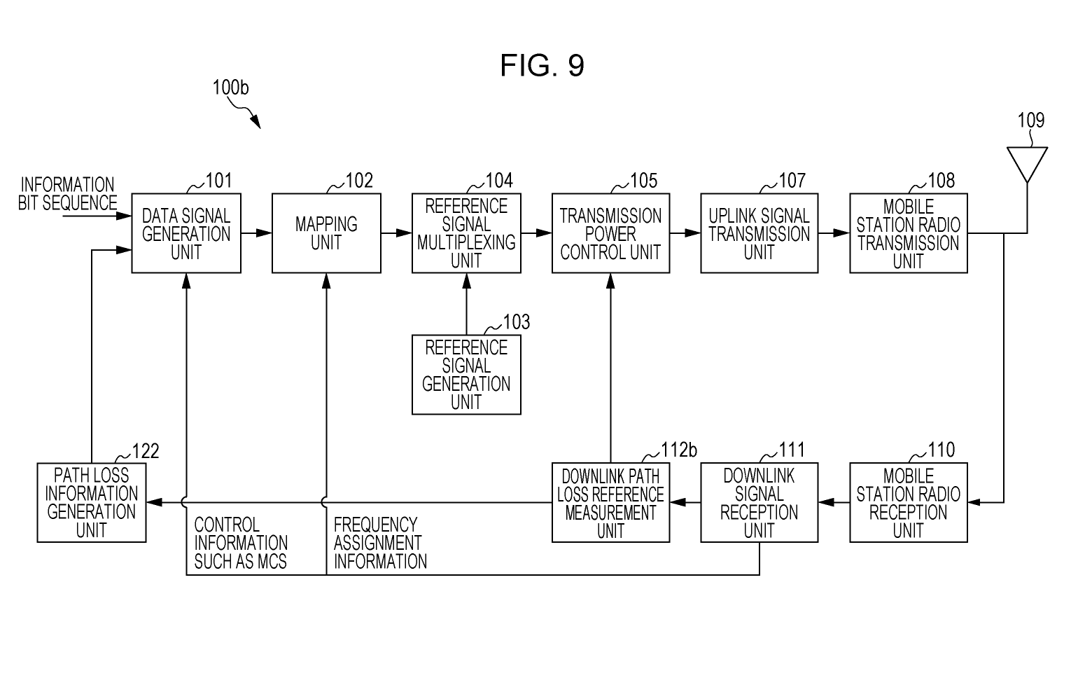

FIG. 9 is a schematic block diagram illustrating the mobile station device 100b according to the second embodiment. It is to be noted that the same components as those illustrated in FIG. 4 have the same functions as those according to the first embodiment, and accordingly the same components as those illustrated in FIG. 4 are given the same reference numerals and specific description thereof is omitted. In the configuration of the mobile station device 100b according to the second embodiment illustrated in FIG. 9, the path loss measurement signal generation unit 106 is removed, a path loss information generation unit 122 is added, and the downlink path loss measurement unit 112 is changed to a downlink path loss measurement unit 112b compared to the configuration of the mobile station device 100 according to the first embodiment illustrated in FIG. 4.

Because uplink path loss measurement is not performed in this embodiment, the mobile station device 100b illustrated in FIG. 9 does not include the path loss measurement signal generation unit 106 unlike the mobile station device 100 illustrated in FIG. 4. On the other hand, whereas the downlink path loss measurement unit 112b has similar functions to those of the downlink path loss measurement unit 112 according to the first embodiment, the downlink path loss measurement unit 112b is different from the downlink path loss measurement unit 112 in that the downlink path loss measurement unit 112b also outputs the measured downlink path loss to the path loss information generation unit 122. In addition, the mobile station device 100b is also different in that the mobile station device 100b includes the path loss information generation unit 122 to which the path loss measured by the downlink path loss measurement unit 112b is input.

The path loss information generation unit 122 generates information regarding a path loss indicating the value of the downlink path loss on the basis of the downlink path loss input from the downlink path loss measurement unit 112b. Here, as an example, the information will be described as 5-bit information that can express the path loss from 0 to 31 dB with 1 dB increments.

It is to be noted that the information regarding a path loss is not limited to this value of the downlink path loss insofar as the information regarding a path loss is information that can be used by the base station device for setting the allowable overlap number. For example, the information regarding a path loss may be information indicating the transmission power of the mobile station device determined on the basis of the path loss. Furthermore, the information regarding a path loss may be a value (also referred to as power headroom (PH)) indicating how large a difference between the transmission power of the mobile station device and available maximum transmission power of the mobile station device, instead.

The path loss information generation unit 122 outputs the generated information regarding a path loss to the data signal generation unit 101 as information to be processed by a higher layer. Thus, the data signal generation unit 101 processes the information regarding a path loss as well as the information bit sequence.

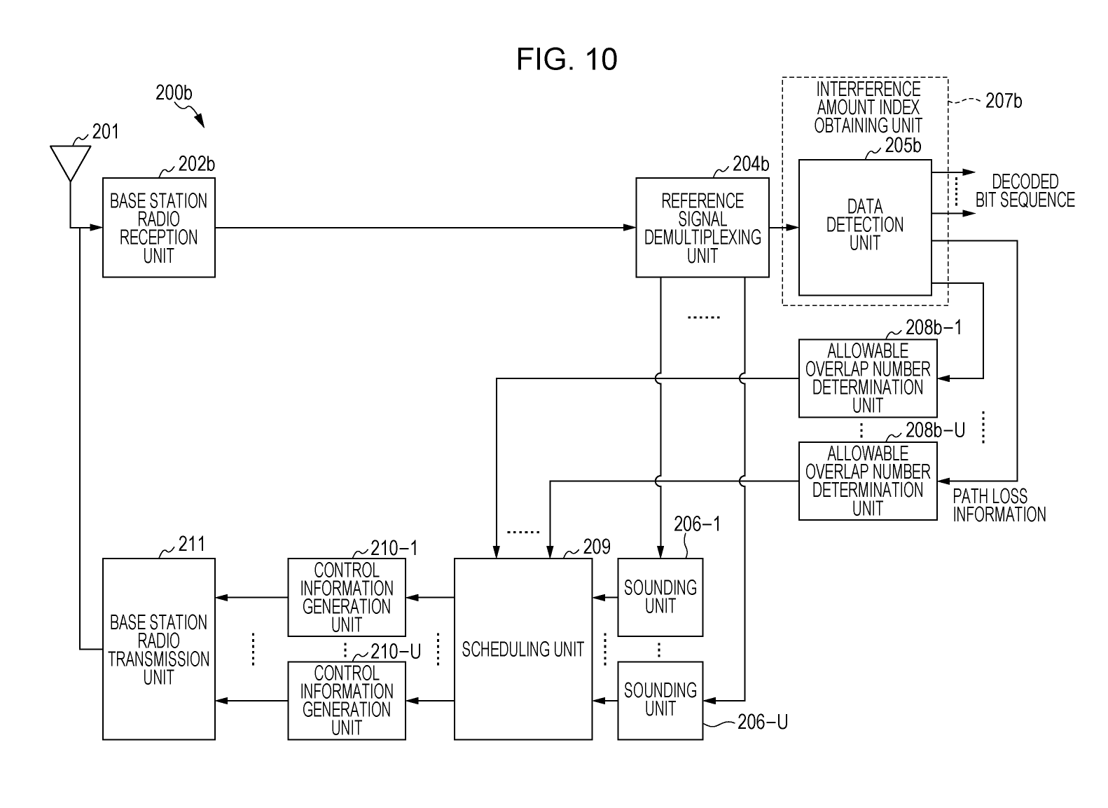

FIG. 10 is a schematic block diagram illustrating the base station device 200b according to the second embodiment. It is to be noted that the same components as those illustrated in FIG. 5 have the same functions as those according to the first embodiment, and accordingly the same components as those illustrated in FIG. 5 are given the same reference numerals and specific description thereof is omitted. In the configuration of the base station device 200b according to the second embodiment illustrated in FIG. 10, the path loss measurement signal demultiplexing unit 203 and the uplink path loss measurement units 207-1, . . . , and 207-U are removed, the base station radio reception unit 202 is changed to a base station radio reception unit 202b, the reference signal demultiplexing unit 204 is changed to a reference signal demultiplexing unit 204b, the interference amount index obtaining unit 207 is changed to an interference amount index obtaining unit 207b, and the allowable overlap number determination unit 208 is changed to an allowable overlap number determination unit 208 compared to the configuration of the base station device 200 according to the first embodiment illustrated in FIG. 5. In addition, the interference amount index obtaining unit 207b includes a data detection unit 205b.

The base station radio reception unit 202b has the same functions as the base station radio reception unit 202 according to the first embodiment, but the base station radio reception unit 202b is different from the base station radio reception unit 202 in that the base station radio reception unit 202b outputs the digital signal after the conversion to the reference signal demultiplexing unit 204b. In addition, the reference signal demultiplexing unit 204b has the same functions as the reference signal demultiplexing unit 204 according to the first embodiment, but the reference signal demultiplexing unit 204b is different from the reference signal demultiplexing unit 204 in the following point. The reference signal demultiplexing unit 204b is different in that the reference signal demultiplexing unit 204b demultiplexes a reference signal transmitted from each mobile station device 100 from the digital signal after the conversion input from the base station radio reception unit 202b.

The data detection unit 205b has the same functions as the data detection unit 205 according to the first embodiment, but the data detection unit 205b is different from the data detection unit 205 in that the data detection unit 205b outputs the information regarding a path loss transmitted from each mobile station device 100b to the allowable overlap number determination unit 208b-i. The allowable overlap number determination unit 208b-i sets the overlap allowable number on the basis of the information regarding a path loss input from the data detection unit 205b.

Assume that a value PL_{allow} [dB] is preset as a threshold of the path loss for allowing a mobile station device to overlap. When the path loss indicated by the information regarding a path loss of an i-th mobile station device 100-i input from the data detection unit 205b is denoted by PL(i) [dB], the allowable overlap number determination unit 208b-i sets the allowable overlap number for the i-th mobile station device 100-i to unlimited if PL(i) is smaller than or equal to PL_{allow} or to zero if PL(i) exceeds PL_{allow}.

It is to be noted that when the information regarding a path loss is 1-bit information as described above, the allowable overlap number determination unit 208b-i determines whether or not to allow the mobile station device to overlap in accordance with whether the information is 1 or 0. In addition, as in the first embodiment, a plurality of thresholds PL_{allow} may be prepared and the allowable overlap number determination unit 208b-i may increase the allowable overlap number stepwise as the path loss indicated by the information regarding a path loss decreases. In addition, when the base station device 100 includes a plurality of reception antennas, the allowable overlap number determination unit 208b-i may set the allowable overlap number to “the number of reception antennas—1” if the path loss is equal to or larger than the threshold or to “unlimited” if the path loss is smaller than the threshold.

In addition, when the information regarding a path loss is information indicating the transmission signal level, the allowable overlap number determination unit 208b-i may set the allowable overlap number on the basis of the transmission signal level. More specifically, the allowable overlap number determination unit 208b-i may set the allowable overlap number on the basis of a comparison between the transmission signal level and the predetermined threshold. In this case, for example, the allowable overlap number determination unit 208b-i sets the allowable overlap number to zero if the transmission level is equal to or larger than the threshold or to unlimited if the transmission signal level is smaller than the threshold.

It is to be noted that the allowable overlap number determination unit 208b-i may include thresholds stepwise and increase the allowable overlap number stepwise as the transmission signal level decreases. Alternatively, when the base station device 100 includes a plurality of reception antennas, the allowable overlap number determination unit 208b-i sets the allowable overlap number to “the number of reception antennas—1” if the transmission signal level is equal to or larger than the threshold or to “unlimited” if the transmission signal level is smaller than the threshold.

When the information regarding a path loss is PH, the allowable overlap number determination unit 208b-i may set the allowable overlap number on the basis of the PH. For example, assume a case in which transmission power PTO of the mobile station device 100b is determined in accordance with the above expressions (1) and (2). In this case, the PH is defined by the following expression.

PH=P_{MAX}−P_{NEED}[dB] (3)

Here, the PH is surplus transmission power, and because the transmission power depends on the bandwidth used for transmission, the bandwidth needs to be taken into consideration for the transmission power level at each frequency. Therefore, when the base station device 200b estimates the transmission power level at each frequency used by the mobile station device 100b on the basis of the PH, an estimated transmission power level p_{T} is calculated by the following expression.

p_{T}=P_{MAX0}−max(PH,0)−10 log₁₀(W) (4)

Here, P_{MAX0} denotes reference maximum transmission power configured by the base station device 200b, and when the base station device 200b can recognize the maximum transmission power of each mobile station device 100b, P_{MAX0} equals P_{MAX}. In addition, max(a, b) denotes a function that uses a or b, whichever is larger. The allowable overlap number determination unit 208-i calculates the estimated transmission power level p_{T} using the expression (4) on the basis of the PH input from the data detection unit 205b and bandwidth information that can be obtained from the scheduling unit 209.

The allowable overlap number determination unit 208-i then sets the allowable overlap number on the basis of the estimated transmission power level p_{T}. More specifically, the allowable overlap number determination unit 208-i sets the allowable overlap number on the basis of a comparison between the estimated transmission power level p_{T} and the predetermined threshold. For example, the allowable overlap number determination unit 208-i sets the allowable overlap number to zero if the estimated transmission power level p_{T} is equal to or larger than the threshold or to unlimited if the estimated transmission power level p_{T} is smaller than the threshold.

<Modification>

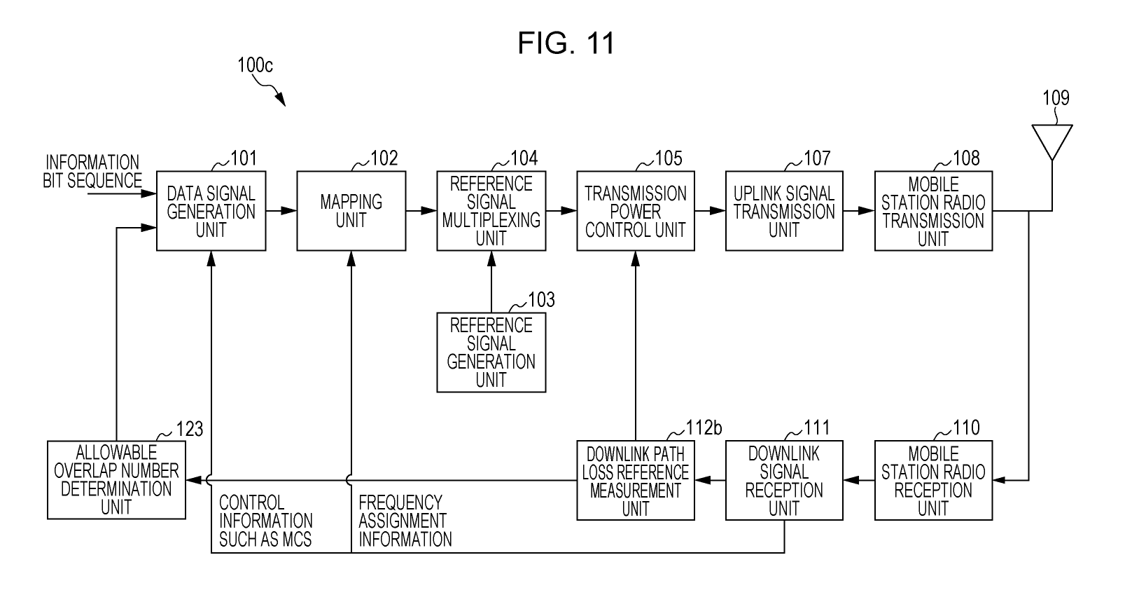

An embodiment has been described in the second embodiment in which the information regarding the downlink path loss measured by the mobile station device 100b is transmitted to the base station device 200b and the base station device 200b sets the allowable overlap number on the basis of the information. However, the method for setting the allowable overlap number is not limited to this, and a mobile station device 100c according to a modification of the second embodiment may set the allowable overlap number in accordance with the value of the downlink path loss. FIG. 11 is a diagram illustrating an example of the schematic blocks of the mobile station device 100c according to the modification of the second embodiment. In the mobile station device 100c illustrated in FIG. 11, the path loss information generation unit 122 is changed to an allowable overlap number determination unit 123 compared to the configuration of the mobile station device 100b illustrated in FIG. 9.

The allowable overlap number determination unit 123 has the same functions as the allowable overlap number determination units 208-1 to 208-U according to the first embodiment illustrated in FIG. 5 and sets the allowable overlap number in accordance with the input value of the path loss. Although the allowable overlap number determination unit 123 is different from the allowable overlap number determination units 208-1 to 208-U in that the input path loss is the downlink path loss, the same process as when the uplink path loss is input may be performed. However, an arbitrary amount of information may be used for information regarding the allowable overlap number to be output, that is, for example, the information may be N-bit information selected from “the N-th power of 2” candidates that have been predetermined, or may be 1-bit information indicating whether the allowable overlap number is 0 or a value other than 0.

As in the case of the path loss information output from the path loss information generation unit 122 illustrated in FIG. 9, the allowable overlap number determination unit 123 outputs the information regarding the allowable overlap number to the data signal generation unit 101. The data signal generation unit 101 transmits the information regarding the allowable overlap number input from the allowable overlap number determination unit 123 to the base station device 200c.

It is to be noted that although the data signal generation unit 101 is configured to transmit the information regarding the allowable overlap number in this modification, the information may be transmitted using a different method insofar as the information can be transmitted to the base station device 200c. For example, the mobile station device 100c may be configured to transmit the information regarding the allowable overlap number as one of control signals transmitted from the mobile station device 100c to the base station device 200c at a frequency or a timing different from one for the data signal.

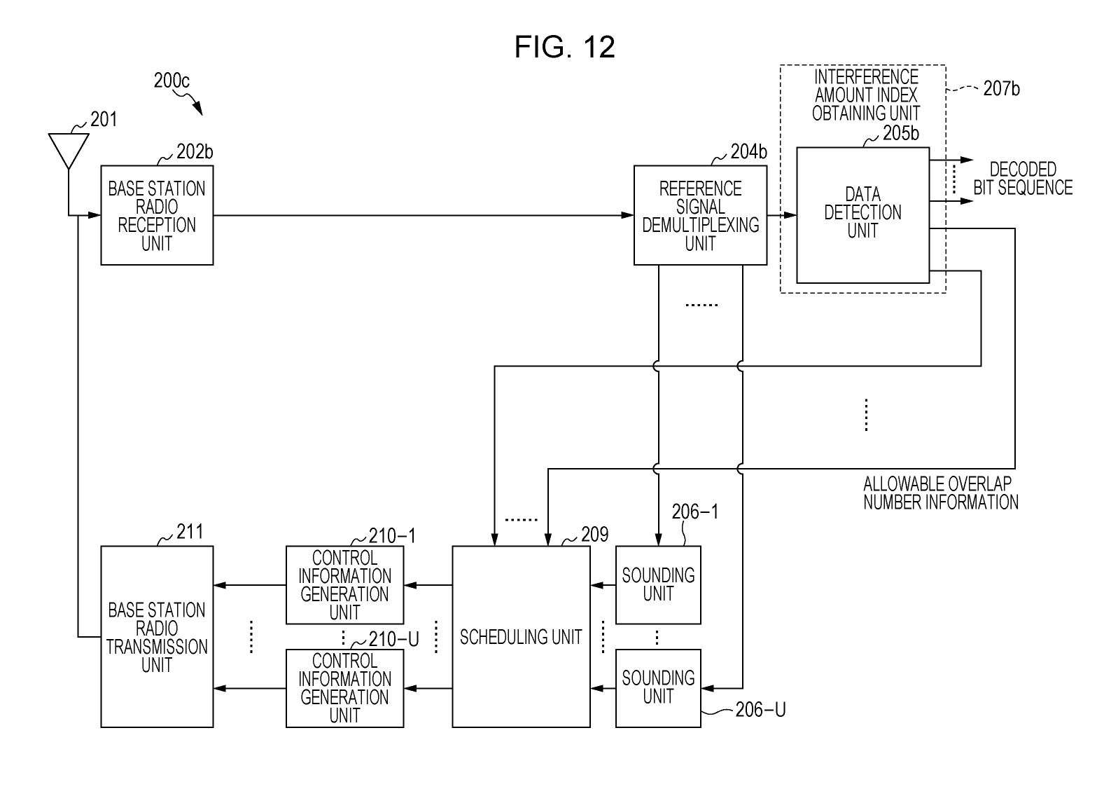

FIG. 12 is an example of a schematic block diagram illustrating the base station device 200c according to the modification of the second embodiment. The base station device 200c illustrated in FIG. 12 is obtained by removing the allowable overlap number determination units 208b-1 to 208b-U from the base station device 200b illustrated in FIG. 10. The allowable overlap number information output from the data detection unit 205b is input to the scheduling unit 209 and subjected to scheduling as in the first embodiment. When the allowable overlap number for each mobile station device 100c is transmitted not as a data signal but as a control signal as described above, however, the allowable overlap number is input to the scheduling unit 209 not from the data detection unit 205b but from the control information extracted from the output of the base station radio reception unit 202b.

It is to be noted that the allowable overlap number determination unit 208b-i may include thresholds stepwise and increase the allowable overlap number stepwise as the estimated transmission power level p_{T} decreases. In addition, when the base station device 100 includes a plurality of reception antennas, the allowable overlap number determination unit 208b-i sets the allowable overlap number to “the number of reception antennas—1” if the estimated transmission power level p_{T} is equal to or larger than the threshold or to “unlimited” if the estimated transmission power level p_{T} is smaller than the threshold.

In this embodiment, information based on the path loss measured by the mobile station device 100b in the downlink is transmitted to the base station device 200b using a data signal, and the allowable overlap number for each mobile station device 100b-i is determined on the basis of the information. As a result, the base station device 200b can prevent, without measuring the uplink path loss, a mobile station device 100b with which the path loss is large, that is, a mobile station device 100b that is likely to be located at a cell edge, from transmitting a signal while overlapping with another mobile station device, thereby suppressing the amount of interference with another cell.

It is to be noted that although an embodiment has been described in each embodiment in which a path loss between a mobile station and a base station is used as an example of an index of the amount of interference with another cell and the overlap number is limited in order to suppress the amount of interference with another cell, the index of the amount of interference is not limited to this. Another means may be used insofar as the means can be used as an index of the amount of interference with another cell.

For example, when the present invention is applied to a base station device that can share information with a base station device of another cell through a wired core network or the like, the base station device (200 or 200b) estimates the position of a mobile station device on the basis of a difference in the reception power level between the plurality of base station devices that have received signals from the mobile station device (100 or 100b). The base station device (200 or 200b) may then estimate the amount of interference of the mobile station device (100 or 100b) with another cell on the basis of a distance between the mobile station device (100 or 100b) and the other cell, and use the estimated amount of interference as an index of the amount of interference with the other cell.

In addition, each mobile station device (100 or 100b) may include a GPS (Global Positioning System) and transmit the position thereof measured by the GPS to the base station device (200 or 200b). As a result, the base station device (200 or 200b) identifies the position of each mobile station device (100 or 100b). The base station device (200 or 200b) may then estimate the amount of interference of each mobile station device (100 or 100b) with another cell on the basis of a distance between each mobile station device (100 or 100b) and another base station device, and use the estimated amount of interference as an index of the amount of interference with a cell covered by the other base station device.

In short, the interference amount index obtaining unit (207 or 207b) according to each embodiment obtains an index of the amount of interference of the mobile station device 100 with another cell to which the mobile station device 100 does not belong on the basis of a transmission signal received by the base station radio reception unit 202. Next, the allowable overlap number determination unit (208-i or 208b-i) sets the allowable overlap number for the mobile station device that is allowed to use the same frequency as another mobile station device in an overlapped manner in accordance with the index of the amount of interference obtained by the interference amount index obtaining unit. In addition, the allowable overlap number determination unit (208-i or 208b-i) decreases the value of the allowable overlap number as the amount of interference indicated by the index of the amount of interference with another cell becomes larger. The allowable overlap number determination unit (208-i or 208b-i) classifies a plurality of mobile stations into mobile stations that are allowed to overlap in a frequency band and mobile stations that are not allowed to overlap in a frequency band on the basis of the indices of the amount of interference.

The allowable overlap number determination unit (208-i or 208b-i) sets the allowable overlap number for one of the plurality of mobile station devices to be smaller than the number of antennas of the base station device used for reception. In addition, the index of the amount of interference is information regarding a path loss between the base station device 100 and the mobile station device 200. In the first embodiment, part of a transmission signal is a path loss measurement signal that is transmitted from the mobile station device 100 and whose transmission power level is known to the base station device 200. The interference amount index obtaining unit 207 according to the first embodiment includes the uplink path loss measurement section 207-i that calculates the uplink path loss in the transmission from the mobile station device 100 to the base station device 200 as the information regarding a path loss on the basis of the path loss measurement signal. In addition, the allowable overlap number determination unit 208-i according to the first embodiment sets the allowable overlap number for a mobile station device 100 with which the path loss calculated by the uplink path loss measurement section 207 is equal to or larger than the threshold to zero.

In the second embodiment, the information regarding a path loss is, for example, the value of the downlink path loss in the transmission from the base station device 200 to the mobile station device 100, the value being transmitted from the mobile station device. Alternatively, the information regarding a path loss may be, for example, the allowable overlap number for the mobile station device transmitted from the mobile station device. Alternatively, the information regarding a path loss may be, for example, the transmission power level that is transmitted from the mobile station device and that is used by the mobile station device for transmission. Alternatively, the information regarding a path loss may be, for example, information indicating a difference between maximum transmission power that can be used by the mobile station device and transmission power necessary to achieve a certain reception signal level, the information being transmitted from the mobile station device.

In addition, the allowable overlap number determination unit (208-i or 208b-i) may set the allowable overlap number on the basis of a bandwidth of the mobile station device used for transmission. In addition, the allowable overlap number determination unit (208-i or 208b-i) may set the allowable overlap number for each mobile station device and a ratio of frequencies that can be overlapped with another mobile station device to frequencies used by each mobile station device for transmission on the basis of the index of the amount of interference of each mobile station device with another cell. The scheduling unit 209 determines the frequencies used by the mobile station device 100-i for transmission on the basis of the allowable overlap number set by the allowable overlap number determination unit (208-i or 208b-i).

In addition, various processes relating to the mobile station device (100 or 100b) and the base station device (200 or 200b) that have been described above may be performed by recording programs for executing the processes performed by the mobile station device (100 or 100b) and the base station device (200 or 200b) according to each of the embodiments on computer-readable recording media, causing computer systems to read the programs recorded on the recording media, and executing the programs.

It is to be noted that the “computer systems” herein may include hardware such as an OS or a peripheral device. In addition, when a WWW system is used, the “computer systems” include an environment that provides a homepage (or an environment that displays a homepage). In addition, the “computer-readable recording media” refer to storage devices such as writable nonvolatile memories including flexible disks, magneto-optical disks, ROMs, and flash memories, portable media including CD-ROMs, or hard disks built in the computer systems.

Furthermore, the “computer-readable recording media” include recording media that hold the programs for a certain period of time, such as volatile memories (for example, DRAMs (dynamic random-access memories)) incorporated into computer systems that serve as servers or clients at a time when the programs are transmitted through networks such as the Internet or communication lines such as telephone lines. In addition, the programs may be transmitted from the computer systems that have stored the programs in storage devices or the like to other computer systems through transmission media or transmission waves in the transmission media. Here, the “transmission media” that transmit the programs refer to media having a function of transmitting information, such as networks (communication networks) including the Internet or communication lines including telephone lines. In addition, the programs may be ones for realizing part of the above-described functions. Furthermore, the programs may be so-called differential files (differential programs), which can realize the above-described functions in corporation with programs that have already been recorded in the computer systems.

Although the embodiments of the present invention have been described in detail with reference to the drawings, specific configurations are not limited to those according to the embodiments, and designs and the like that do not deviate from the scope of the present invention are also included.

### REFERENCE SIGNS LIST

1, 1b radio communication system
100, 100-1, 100-2, . . . , 100-U, 100b, 100b-1, 100b-2, . . . , 100b-U mobile station device
200, 200-1, 200-2, 200b, 200b-1, 200b-2 base station device
101 data signal generation unit
102 mapping unit
103 reference signal generation unit
104 reference signal multiplexing unit
105 transmission power control unit
106 path loss measurement signal generation unit
107 uplink signal transmission unit
108 mobile station radio transmission unit
109 antenna
110 mobile station radio reception unit
111 downlink signal reception unit
112, 112b downlink path loss measurement unit
122 path loss information generation unit
123 allowable overlap number determination unit
201 antenna
202, 202b base station radio reception unit (reception unit)
203 path loss measurement signal demultiplexing unit
204, 204b reference signal demultiplexing unit
205, 205b data detection unit
206-1, . . . , 206-U sounding unit
207, 207b interference amount index obtaining unit
207-1, . . . , 207-U uplink path loss measurement section
208-1, . . . , 208-U, 208b-1, . . . , 208b-U allowable overlap number determination unit
209 scheduling unit
210-1, . . . , 210-U control information generation unit
211 base station radio transmission unit

1-20. (canceled)

21. A base station device comprising:
an interference amount index obtaining unit configured to obtain an index of an amount of interference of a mobile station device with another cell to which the mobile station device does not belong; and
an allowable overlap number determination unit configured to set, for the mobile station device, an allowable overlap number, which indicates the number of mobile station devices that are allowed to use the same frequency in an overlapped manner, in accordance with the index of the amount of interference obtained by the interference amount index obtaining unit.

22. The base station device according to claim 21, wherein the allowable overlap number determination unit is configured to decrease a value of the allowable overlap number as the amount of interference indicated by the index of the amount of interference becomes larger.

23. The base station device according to claim 21, wherein the allowable overlap number determination unit is configured to set, on the basis of the index of the amount of interference, the mobile station device to define either a mobile station device that allows another mobile station device to use a frequency band used by the mobile station device in an overlapped manner or a mobile station device that does not allow another mobile station device to use the frequency band in an overlapped manner.

24. The base station device according to claim 21,
wherein the allowable overlap number determination unit is configured to set, on the basis of the index of the amount of interference, the mobile station device to define either a mobile station device whose allowable overlap number is smaller than the number of antennas of the base station device used for reception or a mobile station device whose allowable overlap number is equal to or larger than the number of antennas of the base station device used for reception.

25. The base station device according to claim 21, wherein the index of the amount of interference is information regarding a path loss between the base station device and the mobile station device.

26. The base station device according to claim 25, further comprising:
a reception unit configured to receive a path loss measurement signal that is transmitted from the mobile station device and whose transmission power level is known to the base station device,
wherein the interference amount index obtaining unit is configured to include an uplink path loss measurement section that calculates, on the basis of the path loss measurement signal, an uplink path loss in transmission from the mobile station device to the base station device as the information regarding a path loss.

27. The base station device according to claim 26, wherein the allowable overlap number determination unit is configured to set the allowable overlap number for the mobile station device with which the uplink path loss calculated by the uplink path loss measurement section is equal to or larger than a threshold to zero.

28. The base station device according to claim 25, further comprising:
a reception unit configured to receive the information regarding a path loss from the mobile station device,
wherein the allowable overlap number determination unit is configured to set the allowable overlap number for the mobile station device in accordance with the information regarding a path loss received by the reception unit.

29. The base station device according to claim 28, wherein the information regarding a path loss is a value of a downlink path loss in transmission from the base station device to the mobile station device.

30. The base station device according to claim 28, wherein the information regarding a path loss is the allowable overlap number for the mobile station device.

31. The base station device according to claim 28, wherein the information regarding a path loss is a transmission power level of the mobile station device used for transmission.

32. The base station device according to claim 28, wherein the information regarding a path loss is information indicating a difference between available maximum transmission power of the mobile station device and transmission power necessary to achieve a certain reception signal level.

33. The base station device according to claim 21, wherein the allowable overlap number determination unit is configured to set the allowable overlap number on the basis of a bandwidth of the mobile station device used for transmission.

34. The base station device according to claim 21, wherein the allowable overlap number determination unit is configured to set, in accordance with the index of the amount of interference of the mobile station device with another cell, a ratio of a band in which the mobile station device is allowed to overlap with another mobile station in the same cell to a band of the mobile station device used for transmission.

35. The base station device according to claim 21, further comprising:
a scheduling unit configured to determine, on the basis of the allowable overlap number set by the allowable overlap number determination unit, a frequency used by the mobile station device for transmission.

36. A method for determining an allowable overlap number executed by a base station device, the method comprising:
an interference amount index obtaining procedure for obtaining an index of an amount of interference of a mobile station device with another cell to which the mobile station device does not belong; and
an allowable overlap number determination procedure for setting the allowable overlap number, which indicates the number of mobile station devices allowed to use the same frequency in an overlapped manner, in accordance with the index of the amount of interference obtained in the interference amount index obtaining procedure.

37. A mobile station device comprising:
a downlink path loss measurement unit configured to measure a downlink path loss using a signal received from a base station device;
an allowable overlap number determination unit configured to set an allowable overlap number, which indicates the number of other mobile station devices allowed to use the same frequency in the same cell in an overlapped manner, on the basis of the downlink path loss measured by the downlink path loss measurement unit; and
a transmission unit configured to transmit the allowable overlap number set by the allowable overlap number determination unit to the base station device.
